(19) United States
(12) Patent Application Publication
(10) Pub. No.: US 2005/0028199 A1
(43) Pub. Date: Feb. 3, 2005

(54) Personal video recorder user interface

(76) Inventor: George R. Borden IV, Portland, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 10/786,516

(22) Filed: Feb. 24, 2004

Related U.S. Application Data
(60) Provisional application No. 60/491,462, filed on Jul. 30, 2003.
(60) Provisional application No. 60/535,120, filed on Jan. 6, 2004.

(51) Int. Cl. H04N 7/14; H04N 5/50

(52) U.S. Cl. 725/40; 725/39; 348/569

(57) ABSTRACT

A user interface suitable for a personal video recorder.

This applications claims the benefits of U.S. patent application Ser. No. 60/491,462 filed Jul. 30, 2003 and U.S. patent application Ser. No. 60/535,120 filed Jan. 6, 2004.

### BACKGROUND OF THE INVENTION

The present invention generally relates to user interface for recording and a user interface for browsing video content on a personal video recorder.

As the number of television stations in a metropolitan area or on a cable network has increased, the number of programs of potential interest that are presented to a viewer has risen dramatically. With the use of dish antennas capable of receiving direct satellite signals, the multitude of programs available to the viewer has further increased.

A common type of personal video recording device uses a digital recording medium, such as a recordable digital video disc or hard drive, to record video content. The personal video recorder is primarily used to record video broadcast or other available video content for viewing at a different time. Typical personal video recorders include an electronic programming guide to assist the user in selecting programs for recording. Additionally, the electronic program guide normally includes title, channel, and actor information to allow the user to select from a list of existing programs.

The user will have a tendency to record numerous programs on the personal video recording device, typically to the limit of the storage capacity of the personal video recording device. With a large amount of video recorded on the personal video recorder it has become increasingly evident that it has become problematic for the user to effectively select the desirable content for viewing at any particular time. Accordingly, a need exists for providing an interface that permits effective recording and selection of the potential video content available. However, without such electronic program guide information associated with the video content it becomes more problematic to select programs for recording or otherwise selecting among the programs recorded by the personal video recorder for subsequent viewing.

### BRIEF DESCRIPTION OF THE DRAWINGS

FIG. 1 illustrates a user interface for a personal video recorder.

FIG. 2 illustrates standard playback mode.

FIG. 3 illustrates a video recorder for adding a recording.

FIG. 4 illustrates a message for adding a recording.

FIG. 5 illustrates a list for a set of recordings.

FIG. 6 illustrates editing the set of recordings.

### DETAILED DESCRIPTION OF THE PREFERRED EMBODIMENT

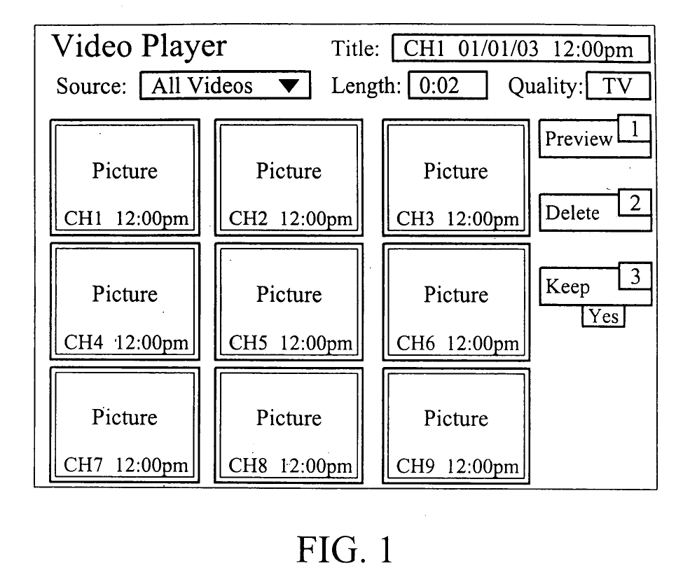

A personal video recorder may record video content onto a recordable medium, such as a hard drive. A large selection of different potential video content may be recorded by the system onto the recordable medium based upon some criteria. Each of the available recorded programs on the personal video recorder may be presented to the user in the form of plurality of different video clips, with each video clip associated with a different recorded program. In many cases, a personal video recorder may be a stand alone box, a computer system, or a television with an integrated recording technique. Referring to FIG. 1, the video clips are preferably presented to the user in the form of an x-y grid with a key frame being illustrated. In order to obtain more information regarding the recorded program associated with the key frame, so that the user may select the most appropriate content, a video clip of the video may be presented by selecting one of the key frames. In this manner the user may visually observe key frames associated with a video and thereafter select a key frame to observe a video clip associated with the video.

The length of the selected video clip or video, the quality of the selected video clip-or video, and the source location of the selected video clip or video, may also be presented to the user. A video clip preview mode may be entered automatically by inactivity of the user or otherwise by the user electing a preview mode. The preview mode presents a portion of the selected video clip, such as 15 seconds, then the preview mode presents subsequent video clips. In this manner, a sequence of video clips may be presented to the user without user intervention. The preview mode may present the video in full screen mode or otherwise in a larger window than the size provided for the key frame. If desired, the preview mode may automatically be entered by a sufficient duration of inactivity, such as 1 minute. Pressing any button on the remote control, or otherwise, may be used to exit the preview mode.

Since the system may automatically record different videos and thereafter automatically create a respective video clip associated with the different videos, the user may determine after viewing the key frame or video clip whether the associated video is desirable. In this case, the user may delete or keep the video, associated video clip, and key frame by pressing the delete or keep button, respectively. In addition, because the personal video recorder tends to have limited storage capability the older video clips may be automatically deleted to provide storage space for new video clips. The auto-delete function may be selectively turned on and off by the user.

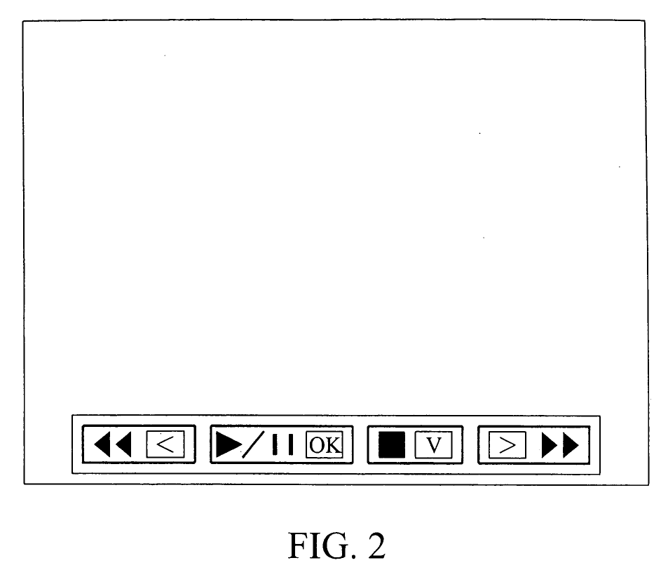

Referring to FIG. 2, the standard video playback mode permits typical video features such as rewind, pause, stop, fast forward, fast rewind, which may be controlled by the remote control and/or icons presented on the display. After a sufficient duration, the controls may be removed from the screen so that the user may view the video clip without any overlays. This mode is useful for full-screen playback where the controls would otherwise overlay the video.

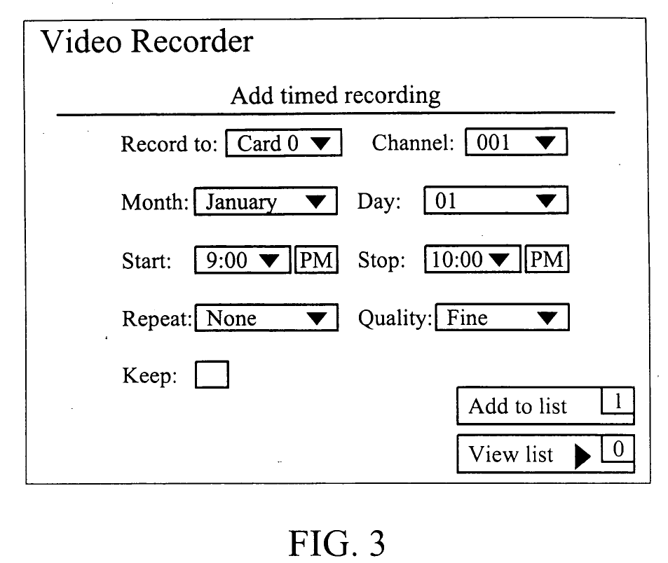

Referring to FIG. 3 the system may include a set of recording functions, such as where to record to, channel to record, month to record, day to record, time to start recording, time to stop recording, whether to repeat the recording, the quality to record, and whether to save these settings. Also, a list of these settings maybe crated by selecting “add to list” and the resulting list may be viewed by selecting “view list”.

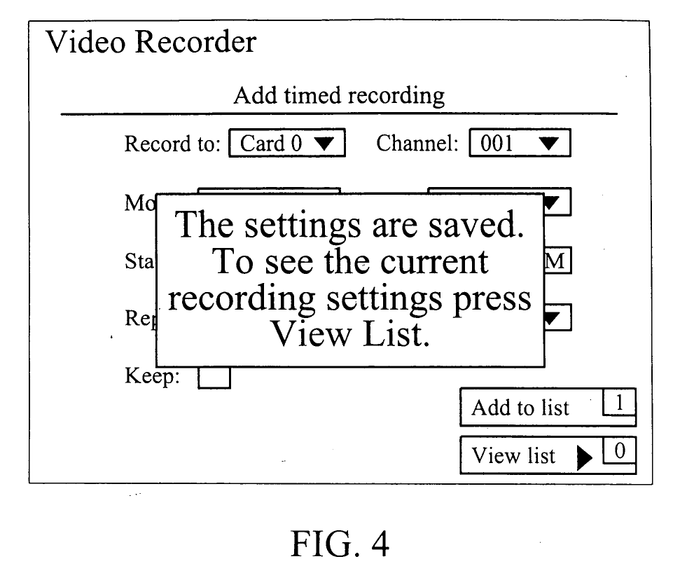

Referring to FIG. 4, when the user presses “add to list” a message may be temporarily displayed to provide feedback and notices to the user. For example, the feedback may include a warning that there is already a recording for the selected time and channel. Also, a warning may be provided that there is insufficient storage capability to record the selected content.

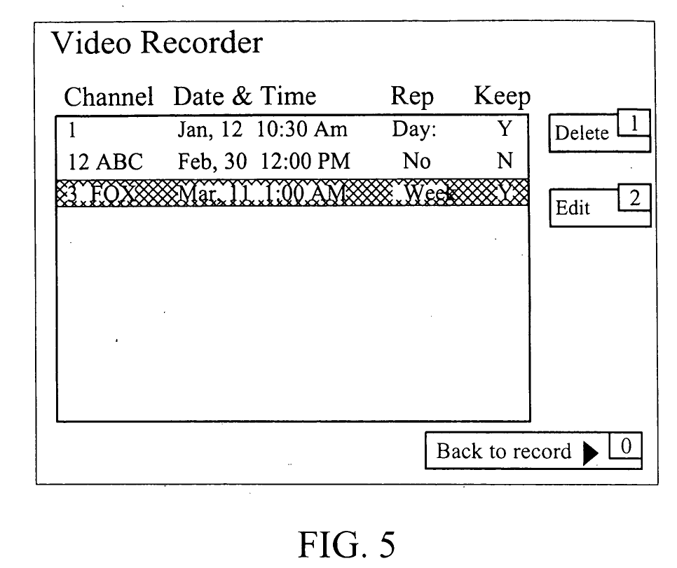

Referring to FIG. 5, the user may edit the list of saved preferences resulting from the “add to list” feature. The user may edit or delete the settings. The “REP” entry indicates whether the recording should be periodically repeated or whether it is a “one time” recording. Also, the frequency of the recording may likewise be displayed, such as hourly, daily, weekly, and monthly. In addition, after recording the desired content the “KEEP” entry indicates whether the preference should be automatically removed from the list or not. Other information is likewise presented.

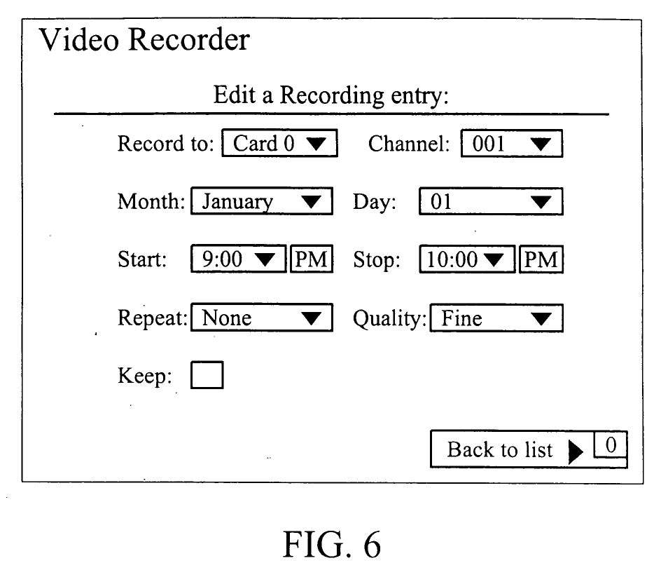

Referring to FIG. 6, the user may edit the recording entry if desired.

While any technique may be used to create the video clips of portions of the videos, it has been determined that many broadcast type programs tend to have similar characteristics during similar portions of the video. For example, if a particular program is recorded every Thursday night at 8:00 pm and that program has the same introduction each night, showing the same introduction portion for each video clip will not help the user to distinguish between any of the episodes that are recorded. The portion of the video to use as a video clip is preferably selected by a algorithm that attempts to find portions of the video that will make it easily distinguishable from the other video clips. In this manner, the system preferably compares all or a portion of the other video clips to determine whether a modified technique should be used to create a video clip or otherwise which portion of the video to use for the video clip. Accordingly, the technique creates video clips that are sufficiently different from one another so that the user is able to distinguish similar videos from one another.

This modification of the summarization technique being applied to the video clips is especially useful, , especially in the case of a personal video recorder. For example, in the broad sense the video summarization technique is suitable to summarize the same video clip using the “same” technique resulting in a different summarization because of the other summarization(s).

The technique may be implemented in a number of ways:

First, since it is likely that the first part of the recorded video may contain titles or commercials the technique may skip the first section (e.g., 10%) of the video and begin processing there.

Second, recording rules can be set up to record weekly or daily at a specific time, so the technique can then compare video among different video clips recorded by the same recording rule. If the video clips are determined to be sufficiently similar then that part of the video may be intro-video and will be skipped until the video is no longer the same.

Third, video clips made by the same recording rules can vary the place where they select the clip from based on time alone. Video1's video clip would come from 12% into the video, while video 2's would come from 10% into the video.

Fourth, commercial detection may be done to avoid selecting those portions of the video.

1. A graphical user interface for a personal video recorder comprising:
(a) simultaneously presenting a plurality of different frames associated with a respective video on a display;
(b) presenting a plurality of frames of one of said respective video on said display in response to selecting a respective one of said different frames;
(c) presenting title information, length information, quality information, and source information regarding said plurality of frames.

2. The interface of claim 1 wherein a plurality of said plurality of frames is presented on said display associated with a plurality of respective videos.

3. The interface of claim 1 wherein said plurality of different frames is presented in a two dimensional array.

4. The interface of claim 1 wherein the creation of said plurality of frames of each of said respective videos is based upon, at least in part, the other said plurality of frames.

5. A graphical user interface for a personal video recorder comprising:
(a) simultaneously presenting a plurality of different frames associated with a respective video on a display;
(b) presenting a plurality of frames of one of said respective video on said display in response to selecting a respective one of said different frames;
(c) wherein the creation of said plurality of frames of each of said respective videos is based upon, at least in part, the other said plurality of frames.

6. The interface of claim 5 wherein a plurality of said plurality of frames is presented on said display associated with a plurality of respective videos.

7. The interface of claim 5 wherein said plurality of different frames is presented in a two dimensional array.
